(19) United States
(12) Patent Application Publication
(10) Pub. No.: US 2007/0232288 A1
(43) Pub. Date: Oct. 4, 2007

(54) Service tool for wireless automation systems

(76) Inventors: Norman R. McFarland, Palantine, IL (US); Goeffrey D. Nass, Rolling Meadows, IL (US); Jeff Raimo, Winnetka, IL (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/394,005

(22) Filed: Mar. 30, 2006

(51) Int. Cl. H04Q 7/20

(52) U.S. Cl. 455/423; 455/67.11

(57) ABSTRACT

A service tool accesses a building automation system to configure and confirm design of an installation, monitor and optimize functionality, commission communication protocols, diagnose, analyze and troubleshoot problems, analyze communications between components, adjust and/or reconfigure parameters, monitor, analyze and debug a building automation system, its components, and the like. The service tool provides a man-machine interface to the building automation system and its components by communicating directly and/or indirectly with the system and its components. The interface displays information about the system, its components. The wireless service tool may operate in multiple modes and/or provide multiple functionality.

### BACKGROUND

The invention relates to configuring, commissioning, servicing, monitoring, surveying and/or debugging automation systems, and particularly, wireless building automation systems.

A building automation system may include one or more distributed components and/or groups of components that together form an integrated system for monitoring and controlling environmental conditions, detecting and preventing hazardous conditions, and/or securing the building or portions thereof. The components may include controllers, sensors, switches, alarms, actuators, chillers, fans, humidifiers, and/or air handling units configured to manage heating, ventilation, air conditioning (HVAC), environmental air quality, safety and security, fire, hazard prevention, or other controlled applications for a building or facility. The system components may communicate wirelessly and/or through a wired connection. For example, a temperature sensor or thermostat positioned in a room wirelessly communicates a temperature reading or signal to a controller, and the controller generates a control signal which is wirelessly communicated to an actuator located in the room. The controller also may communicate feedback signals to a central processor through a wireless or wired connection, such as a communications bus or network.

Function-specific or function-directed tools are used to design, configure, diagnosis, service and maintain the system. Tools are used to survey an installation site and/or develop a design specification. Other tools are employed to install, configure, commission components, and optimize the operation of the system and its components. Defects or faults in and deviations from the design specification may be detected and corrected with diagnostic tools. Other tools are configured to periodically and/or continuously monitor the system. A technician may have tools to identify and troubleshoot failures of a component, group of components or the entire system. The tools may not be portable or mobile, may access the building system only through a central dedicated access point, and/or require multiple devices. Installing, servicing, debugging, troubleshooting and maintaining the building automation system may be labor-intensive and require multiple expensive devices.

### BRIEF SUMMARY

By way of introduction, the embodiments described below include methods, processes, apparatuses, and systems for servicing a building automation system. The service tool for wireless building automation systems accesses a building automation system, and the components, and/or groups of components, of the building automation system. The service tool may access a wired building automations system, wireless building automation system or a system that has both wired and wireless components.

The service tool may provide an access point to a building automation system and its components. The service tool may communicate directly with the system and its components and/or indirectly, such as through the central controller. By accessing the system and its components, the service tool provides a portable or mobile portal to the system to configure, commission, service, monitor, troubleshoot, analyze and debug a building automation system and its components. With the service tool, a user, such as a service technician, installer, and or designer, may configure and confirm design of an installation, monitor and optimize system functions, diagnose, analyze and troubleshoot problems, view communications between components, adjust and/or reconfigure parameters, monitor operation of system, its components, or the like.

The service tool may provide a man-machine interface that displays information about the system, or its components. For example, the interface may display information related to the communications between and among the components of a systems, and present information about various system events such as alarms and triggers. The information may be presented in a visual and/or audible format. For example, a text message may describe an operating condition, a graphic display may illustrate a position of a device, an audible alarm may report important or critical information, and an audible voice or pre-recorded message describes an alarm condition or status.

The wireless service tool may operate in multiple modes and/or provide multiple functionalities. The operation modes may include a survey mode, commission/configuration mode, and diagnostic mode. In a survey mode, the tool may analyze an environment, such as a potential or existing installation site for a building automation system, to determine applicability of a wireless system and analyze wireless communication dynamics of the site. In the commission mode, the service tool may set up, install or establish parameters and protocol for building automation system components. The tool may set, analyze and/or diagnose the operation of system components in the diagnostic mode.

In an embodiment, the wireless service tool for building automation system may monitor a wireless building automation system having devices distributed throughout all or portions of a building. The wireless service tool includes a transceiver that wirelessly communicates information with devices of the building automation system. The wireless service tool includes a processor that controls the wireless transceiver to carry out user instructions and to communicate with one or more devices of the wireless building automation system.

The present invention is defined by the following claims. Nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

The components in the figures are not necessarily to scale, emphasis instead being placed upon illustrating the principles of the invention. Moreover, in the figures, like reference numerals designate corresponding parts throughout the different views.

FIG. 1 is an example of a service tool used with an exemplary building automation system.

FIG. 2 is a diagrammatic representation of one embodiment of a device for a building automation system.

FIG. 3 illustrates a controller of a building automation system.

FIG. 4 illustrates a block diagram for an exemplary service tool for a building automation system.

FIG. 5 illustrates an example of a wireless service tool.

FIG. 6 illustrates an example of a man-machine interface for the service tool of FIG. 5.

FIG. 7 illustrates an example of a handheld service tool.

### DESCRIPTION OF THE PRESENTLY PREFERRED EMBODIMENTS

A service tool for building automation systems (“Service Tool”) may be used prior to, during, and after installation of a building automation system. The service tool may be a portable and/or mobile device having a wireless transceiver that provides an access point to a wireless building automation system. The access point may be made via a wireless communication with the building automation system and/or a wired connection with the building automation system via one or more components of a building automation system. The access point may be used to monitor and analyze communications in the building automation system, such as configuration data and quality of a communication. The service tool may be used to survey an installation site, checkout a network, and troubleshoot an installation for a wireless building automation system.

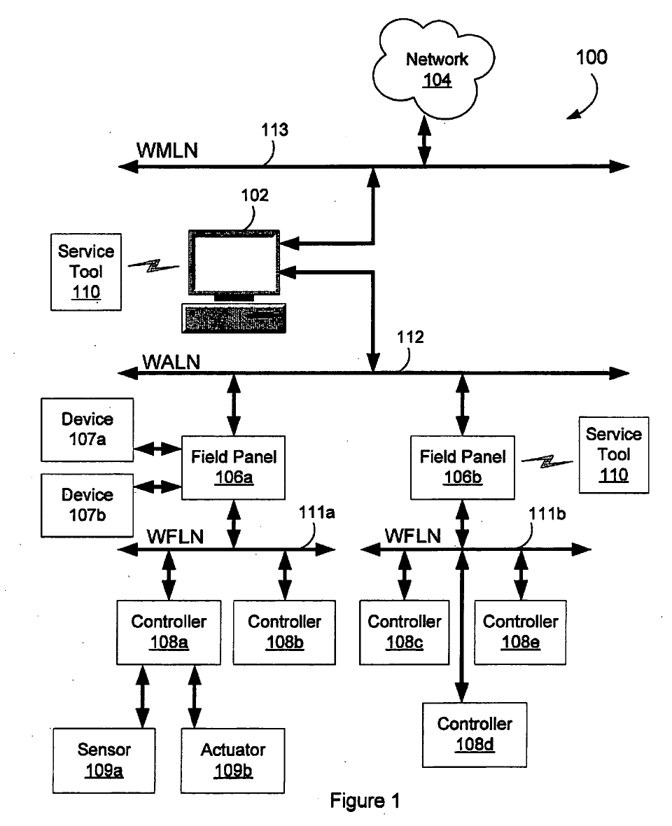

FIG. 1 illustrates a block diagram of a service tool 110 and a building automation system 100. FIG. 1 illustrates an example of a building automation system 100 configured to provide control for heating ventilation and air conditioning (HVAC) for the building and is provided only as an example of a type of automated system. In an embodiment, the building automation system may be an APOGEE™ system provided by Siemens Building Technologies, Inc. of Buffalo Grove, Ill. Although various examples of the service tool 110 and building automation system 100 are described, the service tool 110 may be used in a variety of applications and may be used with many devices and systems. For example, the service tool 110 may be used with any type of control system including a HVAC system, air quality system, industrial control system, security and loss prevention system, hazard detection and/or prevention system, lighting system, combinations or integrations thereof, and the like. The service tool 110 is not limited to the illustrated building automation system 100. In addition, the service tool 110 may be used prior to, during, or after installation of any building automation system.

The building automation system 100 provides control functionality for one or more building, or facility, operations. The building automation system 100 includes one or more components positioned, or distributed, throughout the building or facility. The components may generate and/or receive information related to a specific event, condition, status, acknowledgement, control, combinations thereof and the like. The components also or alternatively may be responsive to signals, may route communications, and/or may carry out an instruction received by or in a signal. The components may communicate or route the information between and among components of the system from a source to a destination.

The building automation system 100 is a multi-tier architecture. A high-speed or high bandwidth communications level may include aggregate collections of sensor and/or actuator data, video or other high bandwidth data or long range communications. Another level may provide point-to-point communication between field panels, controllers, sensors and actuators. For example, components of the system 100 may communicate with other components according to an assigned binding association for the components, forming a mesh network. The components may be commissioned as an operating pair or group according to a binding association. The point-to-point or mesh communication may also include transmitting, routing, or information hopping using low-power wireless RF communications across a network of devices, including controllers, sensors and actuators.

Control processes are distributed to the field panels, controllers, sensors or actuators as appropriate for the particular operations of each device. A sensor reports appropriate sensor information, such as a comparison of a measured value to a desired limit, a range, or a previous measurement. Actuators may process sensor information to determine an appropriate action for the actuator. Controllers monitor the process or action of sensors and actuators and may override the sensor and/or actuators to alter processing based on a regional or larger area control process.

The exemplary building automation system 100 may include at least one supervisory control system or workstation 102, one or more field panels 106a, 106b, and one or more controllers 108a-108e. Each controller 108a-108e, for example, corresponds to an associated localized, standard building control subsystem, such as a space temperature control, air quality control, lighting control, hazard detection, security, combinations thereof, or the like. More or less supervisory control systems 102, field panels 106a, 106b, and controllers 108a-108e may be arranged in a building automation system 100 other than that shown in FIG. 1.

The controllers 108a-108e communicate with one or more sensors 109a using two-way communication protocol. The controllers 108a-108e also may communicate information with one or more actuators 109b using two-way communication protocol. The two-way communication protocols may be a wired, wireless or combination wired and wireless communication. For example, sensor 109a and actuator 109b are commissioned to communicate data and/or instructions with the controller 108a. Sensor 109a may also communicate information directly with actuator 109b using two-way wireless communications.

The controller 108a provides control functionality of each, one or both of the sensor 109a and actuator 109b. The controller 108a controls a subsystem based on sensed conditions and desired set point conditions. The controller 108a controls the operation of one or more actuators to drive a condition sensed by a sensor 109a to a desired set point condition. The controller 108a is programmed with the set points and a code setting forth instructions that are executed by the controller for controlling the actuators to drive the sensed condition to the set point. For example, the actuator 109b is operatively connected to an air conditioning damper and sensor 109a may be a room temperature sensor that provides a feedback signal associated with a present temperature sensed by the sensor or associated with a relative temperature change. If the sensed temperature sensed by the sensor 109a exceeds a threshold, the actuator may respond accordingly to open a damper, allowing conditioned air to flow into a room. The sensor 109a may communicate the sensed condition to the actuator 109b. The sensor 109a additionally or alternatively communicates the sensed condition to the controller 108a which provides an appropriate control signal to the actuator 109b. The controller 108a may monitor communication and performance of the sensor 109a and actuator 109b.

Sensor, actuator, and set point information may be shared among or common to controllers 108a-108e, field panels 106a-106b, work station 102, and any other components or elements that may affect control of the building automation system 100. To facilitate sharing of information, groups of subsystems, such as those coupled to controllers 108a and 108b, are organized into wireless field or floor level networks (“WFLN's”) and generally interface the field panel 106a. Controllers 108c, 108d and 108e along with the field panel 106b also may communicate via a low-level WFLN data network 111b.

The WFLN data networks 111a 111b are low-level data networks that may use any suitable proprietary or open protocol. The WFLN can communicate via wireless or radio links. Any of a wide variety of WFLN architectures or topologies may be used. For example, the WFLN may utilize a wireless MESH technology to form a MESH network. Interfaces, routers, repeaters and bridges are provided for implementing the WFLN 111a and 111b. While shown as a common bus or interconnection structure, the WFLN may include multiple or different communication links between components with some or no redundancy in any of various patterns. For example, the WFLN may be a wireless MESH network may include multiple nodes that communicate with each other via wireless links. The wireless MESH network establishes a grid of nodes that create redundant paths for information flow between and among the nodes. In the MESH network, information may reach a destination either by a direct point-to-point communication or by an indirect communication where the information is routed or hops among different paths from a source to the destination. The WFLN may be self-forming, self-healing to minimize maintenance needs as an environment changes. The WFLN also allows bi-directional routing for command and control information. Additional, different or fewer networks may be provided. For example, a network may be wired, while other networks may be wireless, one or both wireless networks include wired components, or the networks may be distributed amongst only one, three or more levels.

The WFLN's 111a and 111b may operate in accordance with distinguishable or the same wireless communications protocols. For example, the WFLN 111a operates pursuant to the 802.15.4 communications protocols, but IEEE 802.11x (e.g., 802.11a 802.11b, 802.11c . . . 802.11g), Wi-Fi, Wi-Max, Bluetooth, ZigBee, Ethernet, proprietary, standard, now known or later developed wireless communication protocols may be used. The WFLN 111b may operate using the same or different protocol as the protocol employed by WFLN 111a. Any now known or later developed network and transport algorithms may be used. Communication, transport and routing algorithms are provided on the appropriate devices. Any packet size or data format may be used.

The field panels 106a and 106b coordinate communication of data, information and signals between the controllers 108a-108e and the workstation 102. In addition, one or more of the field panels 106a and 106b may control devices such as HVAC actuators 107a and 107b. The field panels 106a and 106b may control the devices 107a 107b via physical input/output connections. The field panels 106a and 106b accept modification, changes, alterations, and the like from the user with respect to objects defined by the building automation system 100. The objects are various parameters, control and/or set points, port modifications, terminal definitions, users, date/time data, alarms and/or alarm definitions, modes, and/or programming of the field panel itself, another field panel, and/or any controller in communication with a field panel.

The field panels 106a and 106b may communicate upstream via a wireless automation level network (“WALN”) 112 to the workstation 102. The WALN 112 may also or alternatively be a wireless building automation level network (“WBLN”). The workstation 102 includes one or more supervisory computers, central control panels or combinations thereof. The workstation 102 provides overall control and monitoring of the building automation system 100 and includes a user interface. The workstation 102 further operates as a building control system data server that exchanges data with one or more components of the building automation system 100. Through the workstation 102 may also allow access to the building control system data by other applications. The applications are executed on the workstation 102 or other supervisory computers that may be communicatively coupled via a wireless management level network (“WMLN”) 113. The WMLN 113 may be implemented using IEEE 802.11 networking architecture. The WALN 112 and WMLN 113 may also be a wired network or combination wired and wireless network.

The workstation may provide user access to the components of the building automation system 100, such as the field panels 106a and 106b. The workstation 102 accepts modifications, changes, and alterations to the system. For example, a user may use the workstation 102 to reprogram set points for a subsystem via a user interface. The user interface may be an input device or combination of input devices, such as a keyboard, voice-activated response system, a mouse or similar device. The workstation 102 may affect or change operations of the field panels 106a and 106b, utilize the data and/or instructions from the workstation 102, and/or provide control of connected devices, such as devices 107a and 107b, sensors 109a, actuators 109b, and/or the controllers 108a and 108b. The field panels 106a and 106b therefore accept the modifications, changes, alterations and the like from the user.

The workstation 102 may process data gathered from the field panels 106a and 106b and maintain a log of events and conditions. Information and/or data are gathered in connection with the polling, a change of value subscription, query or otherwise. The workstation 102 maintains a database associated with each field panel 106a and 106b, controllers 108a-108e, and sensor 109a, actuator 109b, and devices 107a and 107b. The database stores or records operational and configuration data.

The workstation 102 may be communicatively coupled to a web server. For example, the workstation 102 may be coupled to communicate with a web server via the MLN 113 through a network 104 such as an Ethernet network, a LAN, WLAN, or the Internet. The workstation 102 uses the MLN 113 to communicate building control system data to and from other elements on the MLN 113. The MLN 113 is connected to other supervisory computers, servers, or gateways through the network 104. For example, the MLN 113 may be coupled to a web server to communicate with external devices and other network managers. The MLN 113 may be configured to communicate according to known communication protocols such as TCP/IP, BACnet, and/or other communication protocols suitable for sharing large amounts of data.

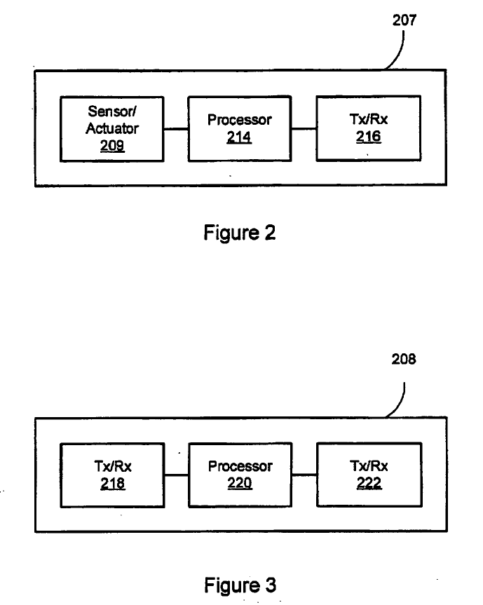

FIG. 2 illustrates a block diagram for an arrangement 207 of a component of a building automation system, such as the building automation system 100 of FIG. 1. The device 207 may be a sensor configured to report conditions and/or events. Additionally or alternatively, the device 207 may be an actuator configured to perform an act in response to instructions. The device 207 includes a sensor/actuator 209, a device processor 214 and a transceiver 216. Additional, different or fewer components may be provided, such as providing a plurality of different or the same types of sensors.

The sensor/actuator 209 may include a collection of sensors that sensing environmental conditions. The sensor/actuator 209 may be configured as a temperature sensor, humidity sensor, fire sensor, smoke sensor, occupancy sensor, air quality sensor, gas sensor, O₂, CO₂ or CO sensor or other now known or later developed sensors. The sensor/actuator 209 may be a micro-electro-mechanical sensors (“MEMS”) or larger sensors for sensing any environmental condition.

The sensor/actuator 209 may include an actuator or collection of actuators such as a mechanical or electromechanical device that controls mechanical operations such as for controlling a damper, heating element, cooling element, sprinkler, alarm or other device. The sensor/actuator 209 may include a valve, relay, solenoid, speaker, bell, switch, motor, motor starter, damper, pneumatic device, combinations thereof or other now known or later developed actuating devices for building automation. For example, the sensor/actuator 209 is a valve for controlling a flow of fluid or gas in a pipe, a relay or other electrical control for opening and closing doors, actuating lights, or starting/stopping motors, or a solenoid to open or close a door or damper, such as for altering air flow. The actuator also may provide visual and/or audio feedback in response to control processes.

The processor 214 implements a control process. The control process may be implemented on a signal measured by the sensor 209. The processor 214 may be a general processor, central processing unit, digital signal processor, control processor, application specific integrated circuit, field programmable gate array, programmable logic controller, analog circuit, digital circuit, combinations thereof or other now known or later developed devices for implementing a control process. The processor 214 has a processing power or capability and associated memory corresponding to the needs of one or more of a plurality of different types of sensors/actuators 209. The processor 214 implements a control process algorithm specific to the sensor/actuator 209. Other control processes may be stored but unused due to a specific configuration.

The transceiver 216 may include a transmitter capable of transmitting information, a receiver capable of receiving or reading broadcast or transmitted information, or a combination transmitter/receiver. In an embodiment, the transceiver 216 that may receive and transmit control information from other components or devices to alter the implemented control process. The transceiver 216 is responsive to the processor 214 or other logic. Rudimentary control algorithms may be carried out by the device 207 to perform a single or multiple functions. The portion of the control algorithm is operated or implemented by the device 207 without the need of further control. For example, room temperature may be controlled using a temperature sensor and one or more corresponding actuators in the room. The processor 214 may be controlled to carry out the control algorithm for the temperature function with in the room.

FIG. 3 illustrates an exemplary controller 208 of a building automation system. The controller 208 includes one or more processors 220 and at least one transceiver 218. The controller may also include a second transceiver 222. One transceiver 218 is operable for communicating over a WFLN and the second transceiver may communicate with devices 207. The transceivers 218 and 222 send and/or receive information to and/or from any one or more of the devices 207 WFLN, and field panels 106 or controllers 108. The controller may transmit data and information with a specific device according to a binding association or to other devices. The information may include control instructions, communications settings or other information transmitted from another device 107 or controller. Additional, different or fewer devices may be provided, such as providing a single transceiver operable to transmit and receive pursuant to one or two different communications protocols.

The processor 220 is an application specific integrated circuit, general processor, digital signal processor, control processor, field programmable gate array, analog circuit, digital circuit, combinations thereof or other now known or later developed device for monitoring, controlling and/or routing. The processor 220 may be an 8, 16, 32 or 64 bit processor operable to route or perform aggregate processing on multiple packets or a packet from multiple data sources.

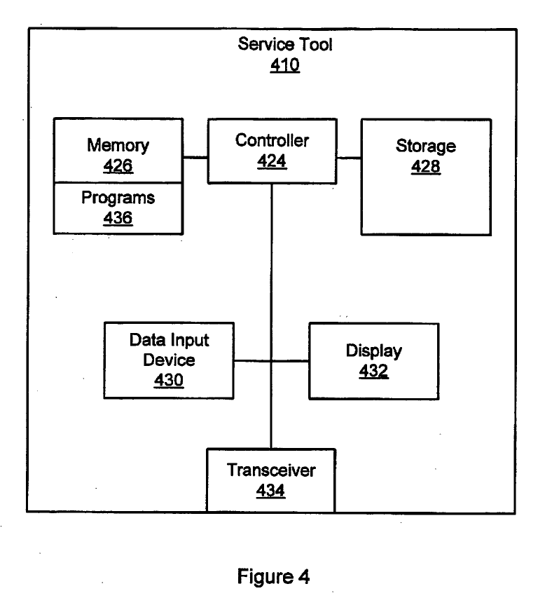

FIG. 4 illustrates a block diagram for an exemplary service tool 410 for a building automation system. The service tool 410 may be any device or network of devices that may be configured or programmed to provide service functionality for a building automation system, and/or installation site for a building automation system. The service tool 410 may be any data processor, a desktop computer, a mobile computer, a notebook computer, a tablet computer, controller system, personal computer, workstation, mainframe computer, server, personal digital assistant (“PDA”), personal communications device such as a cellular telephone, network of computers such as a Local Area Network (“LAN”), a Wireless LAN (“WLAN”) a Personal Area Network (“PAN”), Wireless PAN (“WPAN”) and a Virtual Private Network (“VPN”), combinations thereof and the like. For example, the service tool 410 is a portable handheld device that monitors communications between and among devices of a building automation system and may be used to adjust or modify system parameters.

The service tool 410 includes a controller 424, or a central processing unit (CPU), a memory 426, a storage device 428, a data input device 430, a data output 432, and a transceiver 434. The service tool also includes one or more power connections (not shown), such as a 120Vac, 24 Vac, 24 Vdc and like power connections for supplying operating power for the service tool. The data output device 432 may be a display, monitor, a printer, a communications port, combinations thereof and the like. A program 436 resides in the memory 426 and includes one or more sequences of executable code or coded instructions. The memory may be a random access memory (“RAM”), read-only memory (“ROM”), programmable read-only memory (“PROM”), erasable programmable read only memory (“EPROM”), electronically erasable programmable read only memory (“EEPROM”), Flash memory or any combination thereof or any memory type existing now or in the future. The program may be implemented as computer software or firmware including object and/or source code, hardware, or a combination of software and hardware. The program 436 may be stored on a computer-readable medium, (e.g., storage device 428) installed on, deployed by, resident on, invoked by and/or used by one or more controllers 424, computers, clients, servers, gateways, or a network of computers, or any combination thereof. The program 436 is loaded into the memory 426 from storage device 428. Additionally or alternatively, the code may be executed by the controller 424 from the storage device 428. The program 436 may be implemented using any known or proprietary software platform or frameworks including basic, Visual Basic, C, C+, C++, J2EE™, Oracle 9i, XML, API based designs, and like software systems.

The controller 424 may be may be a general processor, central processing unit, digital signal processor, control processor, application specific integrated circuit, field programmable gate array, analog circuit, digital circuit, combinations thereof or other now known or later developed devices for implementing a control process. The controller 424 executes one or more sequences of instructions of the program 436 to process data. Data and/or instructions are input to the service tool 410 with data input device 430. Data and/or instructions are input to the service tool 410 via the transceiver 434. The controller 424 interfaces data input device 430 and/or the transceiver 434 for the input of data and instructions. Data processed by the controller 424 is provided as to output device 432. For example, data processed by the controller may be presented in a human readable format, such as in textual, graphical, and/or video format on a monitor. The data also or alternatively may be provided in an audible format or combination audible and visual format. The data processed by the controller may also be provided to an external output device and/or stored in the data storage device 428 for later access. The controller 424 through the programs 436 may be configured to provide the functionality of the service tool 410. The controller 424 performs the instructions of the program 436 in memory 426 to provide the features of the service tool 410. The controller 424 may also interface the storage device 428 for storage and retrieval of data.

The transceiver 434 may is a receiver, transmitter, a wireless communication port, a wireless communication device, a modem, a wireless modem and like device configured to wirelessly receive and/or transmit information. Alternatively or in addition, the transceiver may include one or more ports for a wired communication, such as RS-485, Ethernet or any other type of wire port. The transceiver 434 communicates information using one or a combination of one-way and/or two-way wireless communications, such as radio frequency (RF), infra-red (IR), ultra-sound communications, cellular radio-telephone communications, a wireless telephone, a Personal Communication Systems (PCS) and like wireless communication technologies. The transceiver 434 may communicate information or packets of information according to one or more communications protocols or standards, including IEEE 802.11(x), 802.14, 802.15, 802.16, Wi-Fi, Wi-Max, ZigBee, Bluetooth, Voice Over Internet Protocol (VoIP). The transceiver 434 also or alternatively may communicate information and/or packets of information in accordance with known and proprietary network protocols such as TCP/IP, Ethernet and like protocols over a Personal Area Network (PAN), Wireless PAN (WPAN), virtual private network (VPN), Wireless Local Area Network (WLAN) and other networks. The transceiver may also include an interrogator that wirelessly transmits signals to interrogate components of a building automation system.

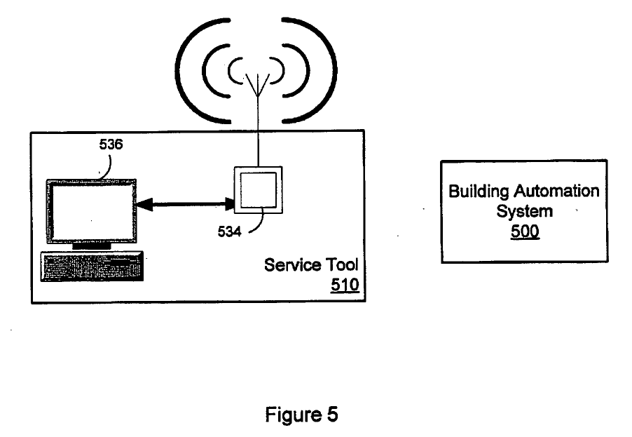

FIG. 5 illustrates an example of a wireless service tool 510. The wireless service tool 510 includes a wireless transceiver 534 coupled to a processor 536, such as a laptop computer, via a RS-232 port or universal serial bus (“USB”) of the processor 536, or any other type of communication connection or coupling between the wireless transceiver 534 and the processor 536.

The wireless transceiver 534 may communicate with the building automation system 500 over one or more RF communication channels. The wireless transceiver may communicate with sensors, actuators, controllers, field panels and other components of the building automation system 500. The wireless transceiver 534 may identify a communication channel and network ID, or any other parameters for wireless communication. Communications parameters may be set within the wireless transceiver 534 and/or processor 536 to allow the wireless transceiver 534 to wirelessly communicate with and monitor communications of the building automation system 500. The wireless transceiver 534 may include an indicator, such as one or more blinking lights, one or more LED's and LCD display and any other indicator, to indicate the wireless transceiver 534 is receiving, transmitting, and/or monitoring, communications. The wireless communication parameters of the building automation system 500 may also be manually of automatically set.

The wireless transceiver 534 provides the data to the processor 536 gathered by monitoring a WFLN of a building automation system 500 or components of the building automation system 500. The building automations system may be the same as or similar to the building automation system 100 described with respect to FIG. 1. Using software resident on the computer, such as Microsoft® HyperTerminal or other application or program, the laptop computer 536 provides a man-machine interface and displays information accessed by the wireless transceiver 534 from the building automation system 500. The processor 536 may also include software to allow a user to wirelessly adjust or modify the building automation system and its components with a command that is communicated to via the wireless transceiver. The processor 536 may store data collected and/or processed.

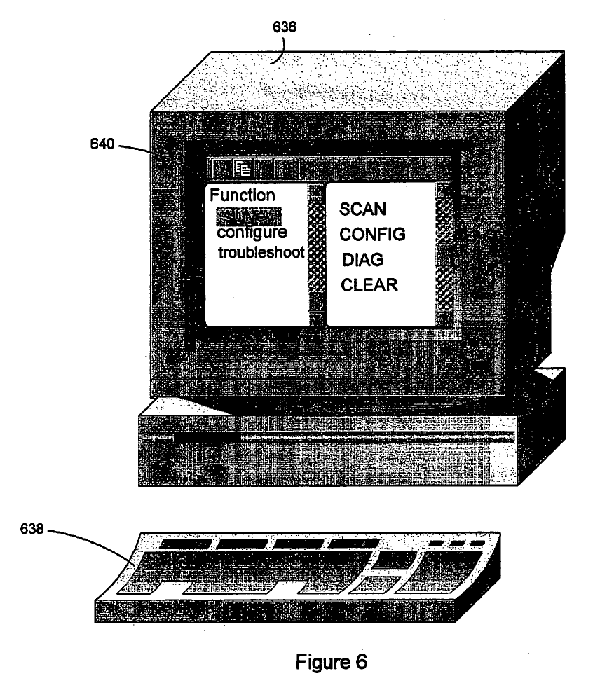

FIG. 6 illustrates an example of a processor 636 configured to provide a man-machine interface for a service tool such as the service tool 510 described with reference to FIG. 5. The processor 636 may be similar to the processor 536 described with respect to FIG. 5 and may include any device that receives, processes, and executes instructions or commands provided by a user. The processor 636 includes an input device 638 such as a keyboard, mouse, touch pad, touch screen, scanner, joystick, microphone, voice recognition software, combinations thereof and the like.

The processor 636 may display a menu 640 for selecting an operation and/or function. Using the input device 638 and the display 640, a user may select to operate the service tool in one or more modes of operation. The processor receives the selection from the user. Based on the selection, the processor may provide control to operate the service tool in the selected mode of operation. Functions and commands associated with the selected operation may be provided to the user. Data collection and gathering may be carried out according to the selected function. For example, a user may select to survey a site or installation. The service tool 510 will operate as a survey tool to check out a network or installation site. The service tool 510 interrogates an environment such as a potential or existing installation site for a building automation system, to determine wireless communication dynamics of the site and analyze applicability of a wireless system for the site. The service tool 510 may determine signal strength and quality of communications at or proximate to discrete locations for the installation site. The processor may control the wireless transceiver to interrogate the building automation system and its devices. A map or diagram of the site also may be pre-loaded on the processor 636. As the user site is surveyed, data related to quality of wireless communications for locations within the site are recorded with an associated location on the map. From the data, hot spots and/or dead spots may be identified and optimal locations for components of the building automation system may be determined.

The service tool 510 may also operate to commission or configure a building automation system 500. The service tool 510 may set up, install, program, or establish parameters and protocol for building automation system 500 and its components. Communications between devices are analyzed and optimized. For example, the service tool 510 gathers information related to quality of communications between components of a group of components. The service tool 510 analyzes the information to identify optimal signal strengths and communicates a command to the components to adjust communication parameter to the optimal level. The service tool also may assign a binding association between components, or commission a communication group of components. For example, a thermostat may be commissioned to communicate with one or more nearby controllers.

The service tool 510 may also operate to troubleshoot the building automation system 500. For example, while monitoring the building automation system 500, the service tool 510 may compare communicated information between components to desired communications. Deviations from set parameters or operating conditions for the component or grouping of components are identified. The parameters may be adjusted or a component identified for replacement. In another example, the service tool 510 may identify a component that is not following or carrying out a desired control algorithm. The service tool 510 may wirelessly reprogram the component with the proper control algorithm. Similarly, the service tool 510 may interrogate the building automation system and/or its components to verify that the component is responsive to alarm or extreme conditions.

The processor may also or alternatively include a display of commands 642. Using the input device 638, the user may select one or more commands to the processor 636. Based on the selection, the service tool 510 will execute the selected one or more commands. The wireless tool 510 may carry out functions on the building automation system as a whole or for specific devices. The user may be enter syntax or select an input syntax to identify how the command is to be performed. For example, a user may configure or scan the entire building automation system, a portion thereof, or a particular device based on the entered syntax. A user may enter or select a HELP command to the processor 636 to display a list of help topics or a command menu listing command options.

The processor 636 may control the wireless transceiver 534 to perform a scan of the building automation system network 500 to check the configuration of the system and verify that the communications among and between devices is robust. The wireless transceiver 534 will scan the devices of the building automation system 500 to establish a sequenced message connection with the devices. The scan is performed using multiple links to different devices or a fewer number of links with data routing. The wireless transceiver 534 will transmit data related to the connections to the processor, where it may be collected, compiled or otherwise stored. A report is generated to show which devices are powered up in the systems and are communicating and able to wireless communicate information. The report may include address information for each device, such as network addresses and configurations for the devices of one or more WFLN's, and identify any duplicate addresses.

The report may also identify errors in communication parameters, such as errors in radio channel communications and/or network ID settings for the devices. The user can scan a particular device by entering a network address or unique identifier (“UID”) for that device. If connection with the device may be made, the report will illustrate the network setting for the device. If the UID is not known, then a partial UID may be used to attempt a connection to the device. When the connection cannot be made, a report indicating such will be provided. The service tool may be used to reassign network addresses or to assign an address, such as for a device without an address. The scan may be re-performed to verify corrections are made.

A binding table that illustrates commissioned pairs or groups of devices (nodes) in the building automation system may also be generated. The binding table may illustrate those devices of the building automation system that have communications with a sensor, actuator, field panel or controller through a transceiver. A device that may be missing or misidentified from a binding association may be identified. Binding associations may be checked and associated table generated according to field panel, for a particular device.

The table or list of devices of the building automation system communicating with a field panel may be displayed with a value that represents the signal strength of the last hop of each message path between the device and the field panel. For example, the user may select to review signal strength for each device associate with a field panel. The table will identify information for the strength of the last receive message and the average strength of all messages receive for a period of time (e.g., the last 60 seconds). The values may also identify whether no communication is present.

The table also may include a cost for communication links or connections. That is the table may identify the reliability and structure of the communication paths between devices, such as between a field panel and an actuator. The cost may reflect how many hops or how many devices are in each path between devices. A value of one may indicate a direct communication between devices whereas a value of 5 may indicate that the there are 5 hops in the connection. The table may also or alternatively include a list of neighbors for a node in the WFLN. For example, devices with which a node may communicate directly may be considered neighbors of the device. The neighbors may be near or proximate the device. The table also may include routing information.

The processor 636 may control the wireless transceiver 534 to perform diagnostics on the building automation system 500. In an embodiment, the service tool may gather diagnostic information such as channel energy values and number of incomplete messages. Using the keyboard 638, the user may enter a command such as ENERGY, DIAG, CLEAR and REBOOT to gather appropriate diagnostic information. The energy command will instruct the processor 636 to control the transceiver to gather information related to energy values for the communication channels for the building automation system. Energy values at each channel over which the building automation system may wirelessly communicate are measured and reported.

A DIAG command will instruct the processor to control the wireless transceiver to gather diagnostic information. Diagnostics may be performed on a node, such as a device or field panel, on the building automation system, or a portion of the system, such as a WFLN. A summary including network address, EUID, number of overlapping messages, number of unacknowledged messages or incomplete transactions, and the like information used in troubleshooting network communication may be provided. A CLEAR command may be used to reset diagnostic count values.

The service tool may also reboot or restart a node, the system, or a portion of the system. The processor 636 may control the transceiver to broadcast a RESTART or REBOOT instruction to the building automation system. The command may hop to all nodes until each node confirms reboot. The reboot may be used to reset binding associations and communications between nodes.

The service tool may also display one or more error messages. An error may occur, for example, due to high network traffic. The message may indicate that a node is not present, multiple nodes are responding to a request to a specific device, an invalid command was received, or that the information requested is unavailable.

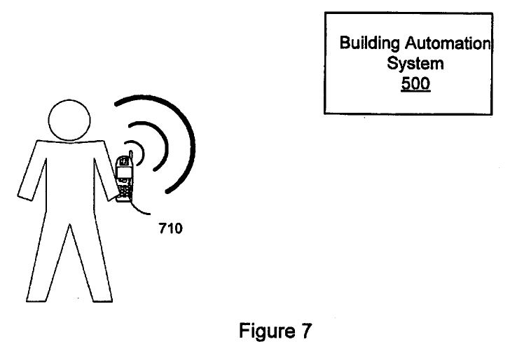

FIG. 7 illustrates an example of a service tool 710 configured as a handheld device, such as PDA device. The service tool 710 displays real-time graphical information related to communications of a building automation system. The information may be displayed on a screen. The user may move about a building or facility environment with the handheld service tool 710. As the user moves about the environment, the service tool may operate to collect data, diagnose problems, and/or configure the building system using one or different links.

While the invention has been described above by reference to various embodiments, it should be understood that many changes and modifications can be made without departing from the scope of the invention. For example, the service tool and its components may be adapted for servicing and troubleshooting industrial control equipment, environmental quality, security, lighting systems and integrated systems including combinations thereof. The service tool may also be configured with mapping software that allows a user to record wireless communication dynamics of an installation site and store the information with a corresponding position on a map of the site. The service tool may be used as a design tool or assistant for a designer. For example, an engineer may use to the tool during a survey of an installation site to select appropriate control equipment and components. The service tool may depict the site as a map on a display. The designer may select components from menu-driven screens and assign the selected component to areas of the building as shown in the map. The information may be compiled and integrated to provide a component list, control algorithms and estimate for the installation site. The service tool may also be used to analyze the designed system. The service tool may be used with integrated systems where, for example, an environmental control system may be integrated with a fire detection and prevention system.

The description and illustrations are by way of example only. Many more embodiments and implementations are possible within the scope of this invention and will be apparent to those of ordinary skill in the art. The various embodiments are not limited to the described environments, and have a wide variety of applications including integrated building control systems, environmental control, security detection, communications, industrial control, power distribution, and hazard reporting.

It is intended that the appended claims cover such changes and modifications that fall within the spirit, scope and equivalents of the invention. The invention is not to be restricted except in light as necessitated by the accompanying claims and their equivalents. Therefore, the invention is not limited to the specific details, representative embodiments, and illustrated examples in this description.

We claim:

1. A service tool to monitor a wireless automation system having a plurality of devices distributed throughout a building, the service tool comprising:
a transceiver configured to wirelessly communicate information with devices of the automation system; and
a processor configured to control the wireless transceiver in accordance with user instructions to communicate with at least one device of the wireless automation system.

2. The service tool of claim 1 further comprising an output device configured to display a report of a communication with the at least one device of the wireless automation system.

3. The service tool of claim 2 where the report comprises diagnostic information of the at least one device.

4. The service tool of claim 2 where the processor and transceiver comprise a unitary part of the service tool.

5. The service tool of claim 1 where the processor controls the wireless transceiver to communicate with a plurality of the devices of the wireless automation system.

6. The service tool of claim 1 where the processor controls the wireless transceiver to scan the communications among a plurality of the devices of the wireless automation system.

7. The service tool of claim 1 where the processor controls the wireless transceiver to read a program for a device of the automation system, the program including code executed by the device to carry out a control operation according to a control algorithm for the device.

8. The service tool of claim 7 where the processor controls the wireless transceiver to wirelessly reprogram the device of the automation system.

9. The service tool of claim 1 where the devices of the automation system are configured to control heating, ventilation and air conditioning functions for at least a portion of a building according to a control algorithm.

10. The service tool of claim 9 where the service tool receives information from at least one device of the wireless automation system associated with a system event.

11. The service tool of claim 9 further comprising a user interface having a display to present information about a communication with the at least one device of the wireless automation system and to receive instructions for controlling a communication with the at least one device.

12. A service tool for a distributed wireless automation system having a plurality of devices configured to wirelessly communicate control information over a network, the service tool comprising:
means for querying devices of the wireless automation system; and
means for receiving information in response to a query of a wireless automation system; and
means for generating a report of the information received in response to the query;
means for displaying the report.

13. The service tool of claim 12, further comprising means for identifying communication properties of at least one device of the wireless automation system.

14. The service tool of claim 12, further comprising means for debugging a communication for at least one device of the wireless automation system.

15. The service tool of claim 14, further comprising means for wirelessly assigning network protocol to the at least one device of the wireless automation system.

16. The service tool of claim 12 further comprising means for displaying user input options.

17. The service tool of claim 12 further comprising means for wirelessly configuring network communication protocol among the devices of the automation system.

18. The service tool of claim 12 where the automation system comprises a building automation system.

19. A method for wirelessly servicing a wireless building automation system, the method comprising:
receiving a user service command;
wirelessly communicating, in response to the user service command, with at least one of a plurality of devices of the building automation system using a mobile transceiver;
determining communication information for the wireless building automation system using the communication; and
generating a report of the wireless communication information.

20. The method of claim 19 further comprising:
recording location specific information related to the wireless building automation system as the transceiver changes locations within a building environment.

21. The method of claim 20 further comprising displaying a real-time graphical representation illustrating a current position of the mobile transceiver with respect to the building environment while the transceiver changes locations within a building environment.
